(19) United States
(12) Patent Application Publication
(10) Pub. No.: US 2026/0280401 A1
(43) Pub. Date: Sep. 17, 2026

(54) LOW-LOSS SUPERCONDUCTING MOTOR AND DESIGN METHOD THEREOF

(71) Applicant: Hunan University, Changsha (CN)

(72) Inventor: Koichi MATSUDA, Changsha (CN)

(73) Assignee: Hunan University, Changsha (CN)

(21) Appl. No.: 19/012,990

(22) Filed: Jan. 8, 2025

(30) Foreign Application Priority Data
Oct. 14, 2024 (CN) 202411433110.7

(51) Int. Cl. H02K 55/04; H02P 6/34

(52) U.S. Cl. CPC H02K 55/04; H02P 6/34

(57) ABSTRACT

A low-loss superconducting motor and a design method thereof are provided. The low-loss superconducting motor includes a vacuum chamber, a stator component and a rotor component are installed in the vacuum chamber, and a protective cover is arranged between the stator component and the rotor component; one of the stator component and the rotor component is equipped with an ordinary conducting coil, and the other is equipped with a superconducting coil, the superconducting coil is applied with a direct current, and the ordinary conducting coil is applied with an alternating current. At the same time, the design method based on the above superconducting motor is also provided, the above-mentioned low-loss superconducting motor and its design method are adopted, and the air gap between the stator component and the rotor component is small.

### CROSS-REFERENCE TO THE RELATED APPLICATIONS

This application is based upon and claims priority to Chinese Patent Application No. 202411433110.7, filed on Oct. 14, 2024, the entire contents of which are incorporated herein by reference.

### TECHNICAL FIELD

The invention relates to the field of superconducting motor technology, particularly, a low-loss superconducting motor and a design method thereof.

### BACKGROUND

The coil of the superconducting motor is made of practical superconducting wire, which has the advantages of high power density and high efficiency, it is a promising motor. The superconducting motor is divided into a fully superconducting motor and a partially superconducting motor according to the structure. The stator and rotor of the motor are both superconductors in the fully superconducting motor, the stator and rotor are installed in the cryostat (vacuum chamber), the air gap between the stator and the rotor is small, and it is easy to form a high magnetic field. However, the superconducting coil with alternating current has a large loss, and the rotor is difficult to rotate at a high speed in the cryostat, the cooling is difficult, and complex mechanical or electrical systems are required to achieve safe operation of the motor. One of the stator and rotor of the motor is a superconductor, and the other is an ordinary conductor in the partially superconducting motor. One of the stator and rotor is installed in the cryostat, and the other is installed outside the cryostat, there is a cryostat wall between the stator and the rotor, so the air gap between the stator and the rotor is large, and it is difficult to generate a high magnetic field, the Joule loss caused by the AC magnetic field still exists.

### SUMMARY

The purpose of the invention is to provide a low-loss superconducting motor and a design method thereof to solve the above technical problems.

In order to achieve the above purpose, the invention provides a low-loss superconducting motor, including a vacuum chamber, a stator component and a rotor component are installed in the vacuum chamber, and a protective cover is arranged between the stator component and the rotor component; one of the stator component and the rotor component is equipped with an ordinary conducting coil, and the other is equipped with a superconducting coil, the superconducting coil is applied with a direct current(DC), and the ordinary conducting coil is applied with an alternating current(AC).

Preferably, the rotor component includes a rotor support frame and several superconducting coils arranged on the rotor support frame, and the stator component includes a stator support frame and an ordinary conducting coil arranged on the stator support frame.

Preferably, several superconducting coils are circumferentially distributed on an interior of the stator support frame, two ends of the stator support frame are fixedly connected to two ends of the vacuum chamber, several constant conducting coils are circumferentially distributed on an outer side of the rotor support frame, two ends of the stator support frame are fixedly connected to the two ends of the vacuum chamber, the two ends of the rotor support frame are connected to the two ends of the vacuum chamber by a rotary bearing, and the superconducting coil and the ordinary conducting coil are located in the same axial position.

Preferably, the protective cover is set on a circumferential side of the rotor support frame, and a radiation heat shield is arranged between the stator support frame and the rotor support frame.

Preferably, the rotor component includes a rotor support frame and several ordinary conducting coils arranged on the rotor support frame, and the stator component includes a stator support frame and a superconducting coil arranged on the stator support frame.

Preferably, a ceil of the stator support frame is a planar structure, and several arrayed superconducting coils are arranged on the planar structure, vertical polarities of the adjacent superconducting coils are different.

Preferably, the planar structure is covered with multiple thermal insulation films, and the protective cover is arranged above the arrayed superconducting coils, the protective cover is made of non-metallic material, and the radiation heat shield is arranged on the protective cover.

Preferably, the rotor support frame is a frame structure, at least one set of ordinary conducting coils is arranged inside the frame structure, and each set of ordinary conducting coils includes at least two ordinary conducting coils.

A design method for the above low-loss superconducting motor, including the following specific steps:
Step S1: Calculating a stator magnetic field according to an actual acceleration required;
Step S2: Calculating a current of the superconducting coil according to the stator magnetic field;
Step S3: Calculating a critical current and a superconductor temperature according to the current of the superconducting coil;
Step S4: Determining a cooling system according to the superconductor temperature.

Preferably, Step S4 is as follows:
Step S41: Calculating an amount of heat transfer, the heat transfer includes a radiation heat transfer, a conduction heat transfer, and a wire heat transfer;
Step S42: Calculating heat required for cooling according to an equilibrium relationship of each heat transfer;
Step S43: Determining the cooling system according to the heat required for cooling.

Therefore, the invention adopts the above-mentioned low-loss superconducting motor and the design method thereof, which has the following beneficial effects:
(1) The stator component and the rotor component are set in the vacuum chamber, a protective cover is arranged between the stator component and the rotor component, one of the stator component and the rotor component is set with an ordinary conducting coil, and the other is set with a superconducting coil, the superconducting coil is applied with a DC, and the ordinary conducting coil is applied with an AC, the air gap between the stator component and the rotor component is small, which is easy to generate a high magnetic field and reduce the Joule loss of the constant conducting coil.
(2) The air or water cooling pipe can be saved, and the temperature is easily controlled.

The following is a further detailed description of the technical scheme of the invention through drawings and embodiments.

### BRIEF DESCRIPTION OF THE DRAWINGS

FIG. 1 is a cross-section of the low-loss superconducting motor in Embodiment 1 of this invention;

FIG. 2 is a side view of the low-loss superconducting motor in Embodiment 1 of this invention.

FIG. 3 is a perspective view of the low-loss superconducting motor in Embodiment 1 of this invention.

FIG. 4 is a cross-section of the low-loss superconducting motor in Embodiment 2 of this invention;

FIG. 5 is a perspective view of the low-loss superconducting motor in Embodiment 2 of this invention.

FIG. 6 is a layout diagram of the ordinary conducting coils of the low-loss superconducting motor in Embodiment 2 of this invention.

FIG. 7 is a structural schematic diagram of the superconducting coil of the low-loss superconducting motor in Embodiment 2 of this invention.

FIG. 8 is a relationship curve between the acceleration of the stage and the stator magnetic field.

FIG. 9 is a relationship curve between the current in the superconducting coil and the stator magnetic field.

FIG. 10 is a relationship curve between the temperature in the superconducting coil and the current in the superconducting coil.

FIG. 11 is the design range diagram of the temperature in the superconducting coil.

FIG. 12 is a relationship curve between the acceleration of the stage and the temperature in the superconducting coil.

FIG. 13 is a thermal analysis model of the interior of the vacuum chamber;

FIG. 14 is an analysis model of the ordinary conducting coil in Embodiment 2.

FIG. 15 is a relationship curve between the heat required for cooling and the temperature in the superconducting coil.

### MARKS IN THE FIGURES

1, vacuum chamber; 2, rotor support frame; 3, stator support frame; 4, ordinary conducting coil; 5, superconducting coil; 6, protective cover; 7, radiation heat shield.

### DETAILED DESCRIPTION OF THE EMBODIMENTS

In the description of the invention, it is necessary to explain that the orientation or positional relationship indicated by the terms up, down, inside, outside, etc. is based on the orientation or positional relationship shown in the attached figures, or is the orientation or positional relationship that is habitually placed when the invention product is used, only to facilitate the description of the invention and simplify the description, rather than to indicate or imply that the device or component referred to must have a specific orientation, be constructed and operated in a specific orientation, and therefore cannot be understood as a limitation to the invention. In the description of the invention, it is also necessary to explain that, unless otherwise clearly defined and limited, the terms set, install, and connect should be understood in a broad sense, for example, it can be fixed connection, detachable connection, or integrated connection; it can be mechanical connection or electrical connection; it can be directly connected or indirectly connected through an intermediate medium, which can be the internal connection of two components. For ordinary technicians in this field, the specific meaning of the above terms in this invention can be understood in detail.

The following is a detailed description of the embodiments of the invention in combination with the attached figures.

### Embodiment 1

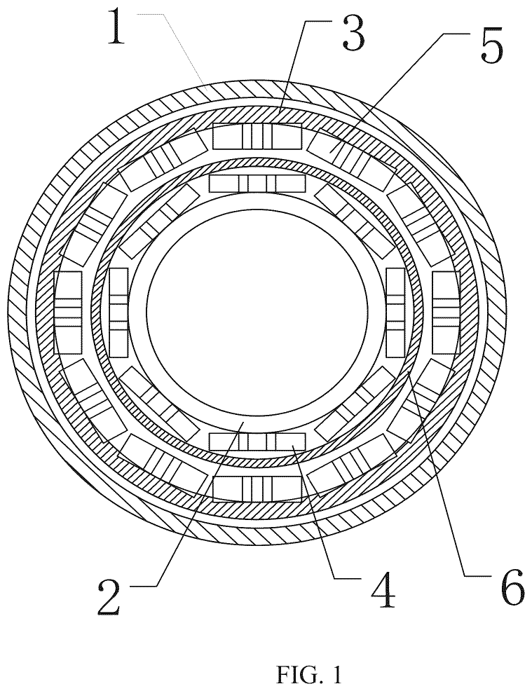

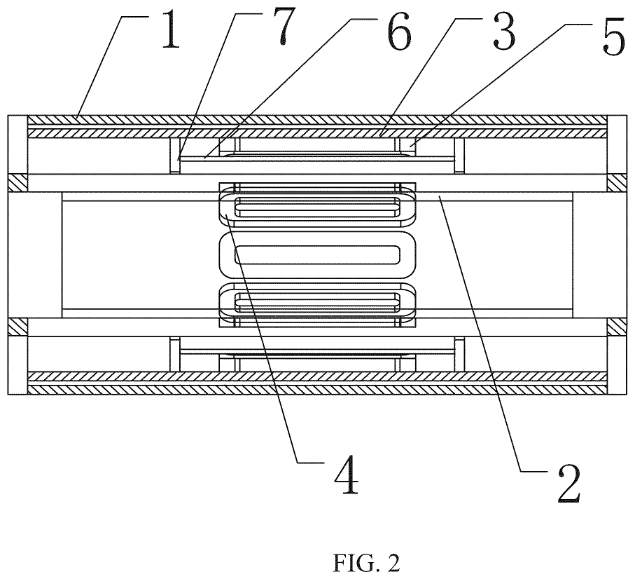

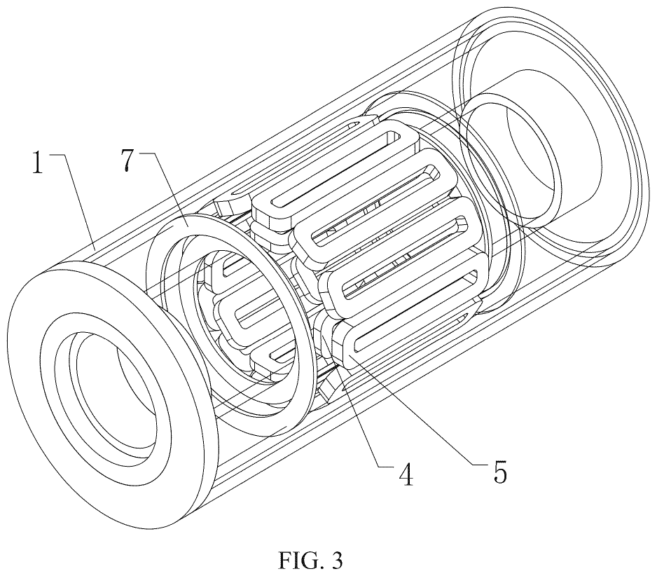

As shown in FIGS. 1-3, a low-loss superconducting motor includes a vacuum chamber 1, a stator component and a rotor component are installed in the vacuum chamber 1, and a protective cover 6 is arranged between the stator component and the rotor component. In this embodiment, the rotor component includes a rotor support frame 2 and several superconducting coils 5 arranged on the rotor support frame 2, and the stator component includes a stator support frame 3 and an ordinary conducting coil 4 arranged on the stator support frame 3.

The rotor support frame 2 and the stator support frame 3 are both hollow shaft structures, several superconducting coils 5 are circumferentially distributed in the interior of the stator support frame 3, the two ends of the stator support frame 3 are fixedly connected to the two ends of the vacuum chamber 1, several ordinary conducting coils 4 are circumferentially distributed in the outer side of the rotor support frame 2, the two ends of the rotor support frame 2 are connected to the two ends of the vacuum chamber 1 through a rotary bearing. The protective cover 6 is set on the circumferential side of the rotor support frame 2. Compared with the air gap between the superconducting coil 5 and the ordinary conducting coil 4 in the existing technology, the air gap between the superconducting coil 5 and the ordinary conducting coil 4 is greatly reduced, and it is easy to generate a high magnetic field. At the same time, alternating current is applied to the ordinary conducting coil 4, and direct current is applied to the superconducting coil 5, the amplitude of alternating current is controlled to reduce the Joule loss in the ordinary conducting coil 4.

A radiation heat shield 7 is set between the stator support frame 3 and the rotor support frame 2, the radiation cooling method is used to cool the ordinary conducting coil 4, which can save air or water cooling pipes, and the temperature control of the ordinary conducting coil 4 is realized by controlling the emissivity of the radiation heat shield 7.

### Embodiment 2

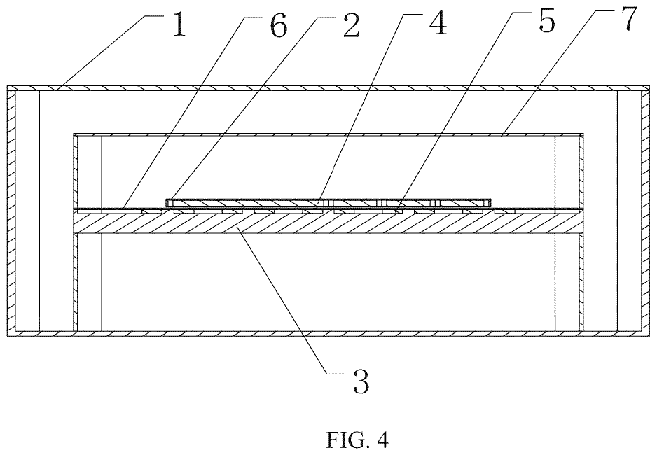

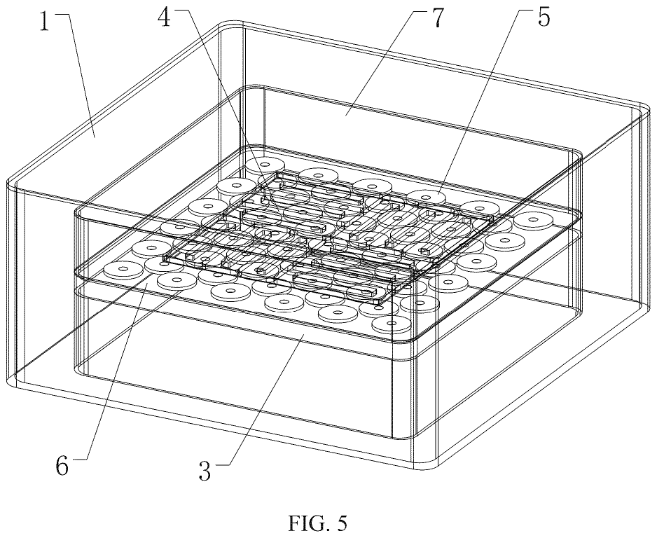

The difference between this embodiment and Embodiment 1 is that the installation positions of the ordinary conducting coil 4 and the superconducting coil 5 are different, and this embodiment is a planar motor. As shown in FIGS. 4-5, the rotor component in this embodiment includes a rotor support frame 2 and several ordinary conducting coils 4 arranged on the rotor support frame 2, the stator component includes a stator support frame 3 and a superconducting coil 5 arranged on the stator support frame 3.

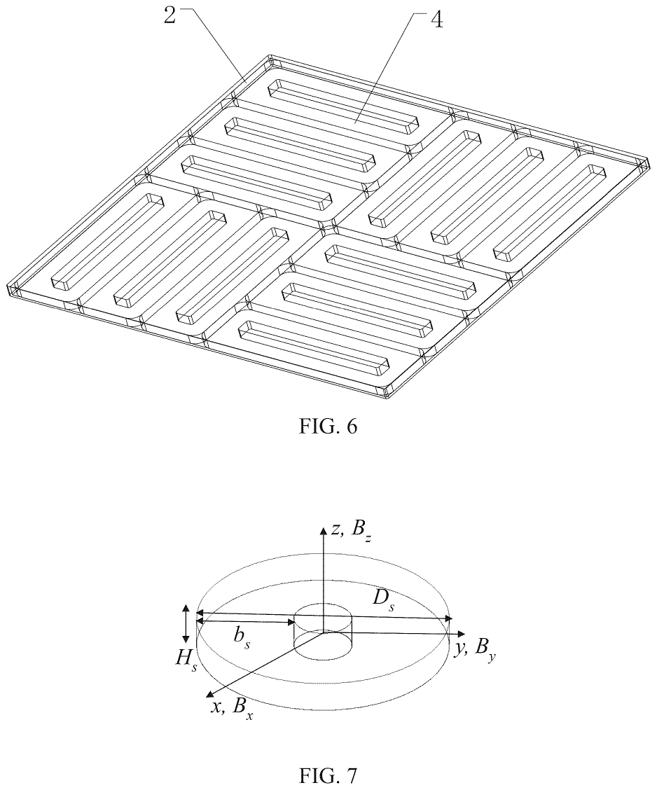

As shown in FIG. 6, the rotor support frame 2 in this embodiment is a rectangular frame structure, the frame structure can also be circular or triangular, and the shape of the frame structure can be adjusted according to the actual situation, it can also be an irregular shape. In this embodiment, three ordinary conducting coils 4 form a set of three-phase ordinary conducting coils 4, the ordinary conducting coil 4 is racetrack-shaped, four sets of three-phase ordinary conducting coils 4 are placed in a rectangular frame structure, and the ordinary conducting coils 4 in the adjacent three-phase ordinary conducting coils 4 are in the same plane and perpendicular to each other, each set of three-phase ordinary conducting coils 4 is applied with an alternating current with a phase difference of 120 degrees.

The number of ordinary conducting coils 4 in each set of ordinary conducting coil 4 can also be adjusted according to the actual situation, such as two-phase or four-phase, and an AC with a phase difference of 90 degrees is applied to the two-phase ordinary conducting coil 4 and the four-phase ordinary conducting coil 4.

The ceil of the stator support frame 3 is a planar structure, and the planar structure is equipped with several arrayed superconducting coils 5, as shown in FIG. 7, the superconducting coil 5 is a cylindrical coil with a height of Hₛ, and the vertical polarities of the adjacent superconducting coil 5 are different, that is, the N-pole and S-pole are arranged alternately. This embodiment is provided with 36 N-poles and 25 S-poles.

The planar structure is covered with multiple insulation films to suppress the radiation heat from the inner wall of the vacuum chamber 1 to maintain a low surface emissivity. The stator support frame 3 is made of G10 material, G10 material has the advantages of low thermal conductivity and relatively high rigidity, the material of the stator support frame 3 can also be adjusted according to the actual performance, and a protective cover 6 is arranged above the arrayed superconducting coil 5, and the protective cover 6 is made of non-metallic material to suppress the eddy current loss caused by the rotor magnetic field. The surface emissivity must be set to a large value to cool the ordinary conducting coil 4. A radiation heat shield 7 is arranged on the protective cover 6.

The air gap length of the traditional partially superconducting motor is 12 mm, while the air gap length of this embodiment is 2 mm.

A design method for the low-loss superconducting motor, the specific steps are as follows:

Step S1: The stator magnetic field is calculated according to the actual acceleration required.

The superconducting coils are periodically arranged at a spacing of 2τ, the magnetic field generated by the superconducting coil array is a fundamental wave with an amplitude of Bₛ and a period of 2τ, then the current with an amplitude of Iₘ and a phase angle of φ flows through a set of three-phase coils of the rotor support frame, the electromagnetic force (Fₓ, F_{z}) acting on it is as follows:

$${F}_{x} = ( 3 / 2 ) K {I}_{m} sin ( ϕ ) {F}_{z} = - ( 3 / 2 ) K {I}_{m} cos ( ϕ ) \qquad ( 1 )$$

where the formula for the force constant K is as follows:

$$K = 2 {B}_{s} {L}_{m} {N}_{m} / {αϛ}_{m} sin α sin ( α + π / 3 ) \qquad ( 2 )$$

α=πbₘ/2τ; Lₘ, bₘ, Nₘ and ζₘ are the length, width, number of turns, and filling factor of the ordinary conducting coil on the rotor support frame respectively;

the force generated by the motor is proportional to the stator magnetic field Bₛ of the superconducting coil and the current Iₘ of the ordinary conducting coil;

according to the number and arrangement of the three-phase coils on the rotor component, the relationship between the acceleration of the stage and the force generated by the motor is as follows.

$${F}_{x} = {MA}_{x} / 2 {F}_{z} = Mg / 4 \qquad ( 3 )$$

where Aₓ is the x-direction acceleration of the stage, g is the gravity acceleration, and M is the mass;
according to the acceleration of the stage Aₓ, the stator magnetic field Bₛ and the ordinary conducting coil current Iₘ are determined.

At present, the widely used planar motor generally adopts the permanent magnet of the Halbach array to replace the superconducting magnet, and the stator magnetic field is Bₛ=0.6T. Suppose Iₘ=25A (≡I₀), Nₘ=300, then the acceleration of the stage is Aₓ=8G. This is equivalent to the acceleration of the wafer stage in modern exposure systems.

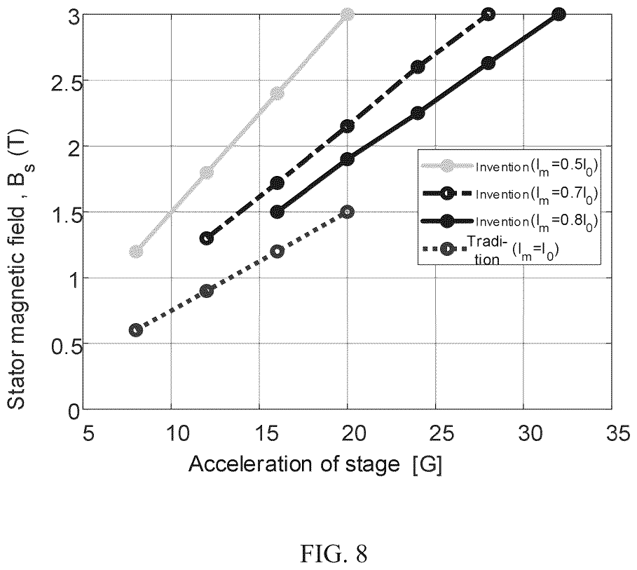

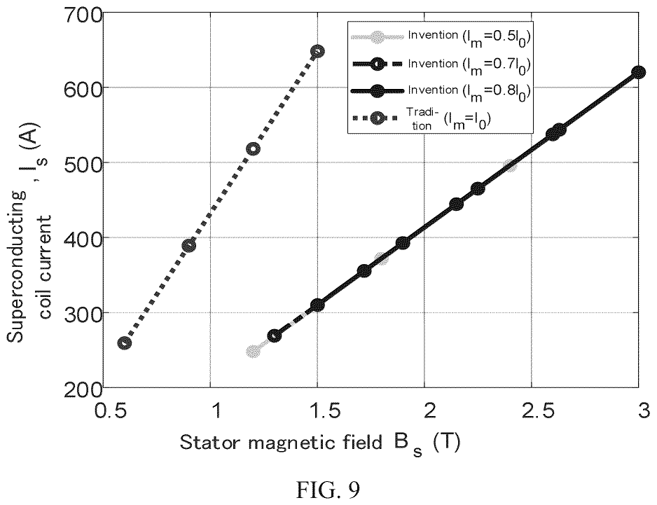

As shown in FIG. 8, for the ordinary conducting coil current Iₘ=0.5 I₀, 0.7 I₀, 0.8 I₀, the stator magnetic field required to achieve the acceleration of the stage (16G to 32G) is calculated according to Formulas (1) to (3).

Compared with the traditional motor, the air gap length between the stator component and the rotor component proposed in this embodiment is smaller, so it is easy to increase the stator magnetic field Bₛ proposed in this embodiment.

Step S2: The current of the superconducting coil is calculated based on the stator magnetic field.

The calculation formula of the stator magnetic field (Bₓ, B_{z}) is as follows:

$${B}_{x} = \frac{{μ}_{0} {J}_{s}}{{2}_{π}} {\int }_{0}^{π} {f}_{x} ( R , Z , θ ) \vert \begin{matrix}{R}_{2} \\ {R}_{1}\end{matrix} \vert \begin{matrix}{Z}_{2} \\ {Z}_{1}\end{matrix} d θ {B}_{z} = \frac{{μ}_{0} {J}_{s}}{2 π} {\int }_{0}^{π} {f}_{z} ( R , Z , θ ) \vert \begin{matrix}{R}_{2} \\ {R}_{1}\end{matrix} \vert \begin{matrix}{Z}_{2} \\ {Z}_{1}\end{matrix} d θ$$

The integral function is as follows:

$${f}_{x} ( R , Z , θ ) = A ξ + x {ξ}^{2} ln ( A + K ) ; \\ {f}_{z} ( R , Z , θ ) = C [ ln ( A + K ) + \frac{ξ}{2 \vert C \vert} ln ( \frac{A - \vert C \vert}{A + \vert C} ) ] - x η {tan}^{- 1} ( \frac{KC}{Ax η} ) ; \\ A = \sqrt{{R}^{2} - 2 Rx ξ + {x}^{2} + {C}^{2}} ; \\ where \\ C = Z - z {J}_{s} = {N}_{s} {I}_{s} / ( {b}_{s} {H}_{s} ) η = sin θ ξ = cos θ \\ K = R - x ξ {R}_{1} = {D}_{s} / 2 - {b}_{s} {R}_{2} = {D}_{s} / 2 {Z}_{2} = {H}_{s} / 2 {Z}_{1} = {H}_{s} / 2$$

where the current in the superconducting coil is Iₛ, μ₀ is the vacuum permeability, Nₛ is the number of turns, Dₛ is the outer diameter, bₛ is the width, and Hₛ is the height. Compared with the traditional motor, the air gap length between the stator component and the rotor component proposed in this embodiment is smaller, as shown in FIG. 9, the relationship curve between the current in the superconducting coil and the stator magnetic field shows that the stator magnetic field proposed in this embodiment can be generated with a smaller superconducting current. Step S3: the critical current and the superconductor temperature are calculated according to the current of the superconducting coil.

The critical current is the maximum current in the superconducting coil. It is a function of the temperature around the superconducting coil T, the magnetic field size |B| and the direction φ. This embodiment adopts the interpolation function obtained from the existing data, and the interpolation function is: Ĩ_{c}(|B|, φ, T). In order to suppress the AC loss, assuming that the critical current I_{c} is much larger than the stator coil current Iₛ, it is expressed as I_{c}=KₛIₛ, and Kₛ is the safety factor, the value of Kₛ is 2 in this embodiment.

The calculation formula of the superconductor temperature is as follows:

$${T}_{s} = min \{ T \text{:} {\tilde{I}}_{c} ( {max}_{{V}_{s}} \vert {B}_{x} \vert , 0 , T ) = {I}_{c} , {\tilde{I}}_{c} ( {max}_{{V}_{s}} \vert {B}_{z} \vert , π / 2 , T ) = {I}_{c} \} ;$$

where Tₛ is the superconductor temperature, and Vₛ is the region of the superconducting coil.

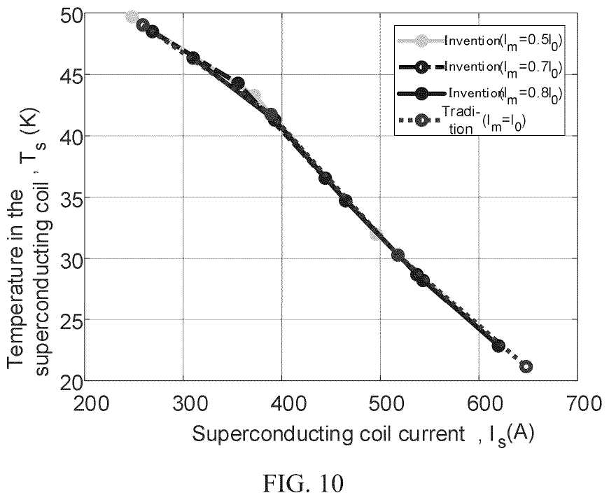

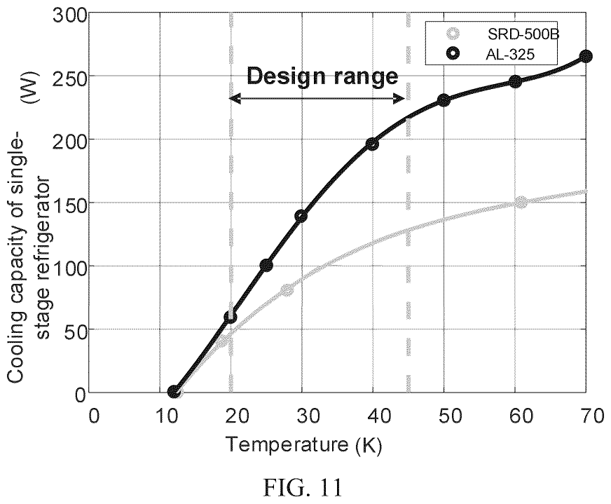

The relationship between the temperature in the superconducting coil and the superconducting coil current is shown in FIG. 10, the cooling capacity of the cryocooler will decrease with the decrease in temperature, as shown in FIG. 11. Therefore, the temperature in the superconducting coil is set at 20 K to 45 K. If a single-stage refrigerator with a large cooling capacity can be used in this temperature range, the advantages of superconducting magnets over permanent magnets will be enhanced.

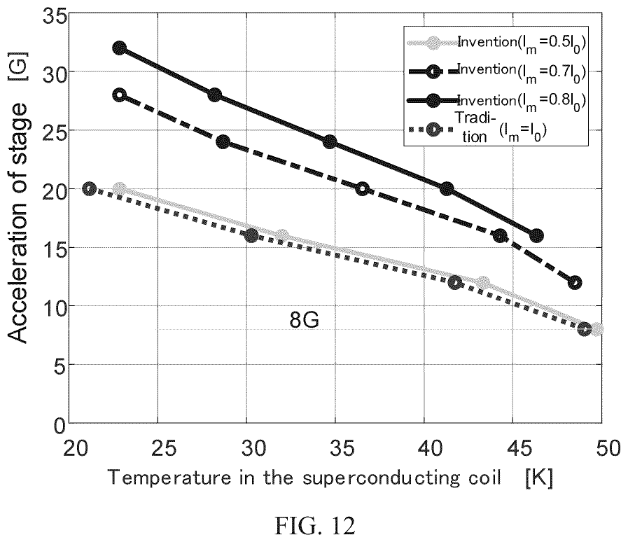

As shown in FIG. 12, the relationship between the acceleration of the stage and the temperature in the superconducting coil is shown, indicating that when Iₘ>0.5I₀, the superconducting motor proposed by the invention can obtain a larger acceleration of the stage than the traditional motor. When Iₘ is 0.7 I₀ or higher, the difference between the two motors is particularly pronounced.

In this embodiment, a single-stage GM refrigerator is used to cool the motor.

Step S4: The cooling system is determined according to the superconductor temperature.

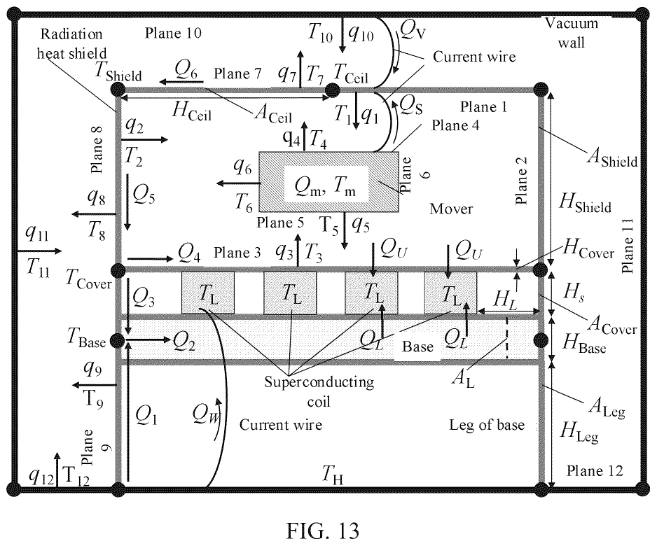

The thermal analysis model of the interior of the motor in this Embodiment is shown in FIG. 13, the interior of the motor is composed of N planes, in this figure, N=12.

Step S41: The amount of heat transfer is calculated, the heat transfer includes a radiation heat transfer, a conduction heat transfer, and a wire heat transfer.

The formula for calculating the radiation heat transfer q=[q₁, q₂, . . . q_{N}]^{T} of each plane is as follows:

$$q = R {P}^{- 1} S$$

$$S = σ [ \begin{matrix}{T}_{1}^{4} & {T}_{2}^{4} & ⋯ & {{T}_{N}^{4} ]}^{T}\end{matrix}$$

$$R = [ {R}_{i j} ] \qquad {R}_{i j} = {A}_{i} ( - {F}_{i j} + {δ}_{i j} {\sum }_{k = 1}^{N} {F}_{i k} )$$

$$P = [ {P}_{i j} ] \qquad {P}_{i j} = - {r}_{i} {F}_{i j} + {δ}_{i j} ( 1 + {r}_{i} {\sum }_{k = 1}^{N} {F}_{i k} ) {r}_{i} = ( 1 - {ε}_{i} ) / {ε}_{i}$$

where εᵢ and Tⱼ are the emissivity and temperature of the plane j, σ is the Boltzmann constant, and Fᵢⱼ is the shape coefficient from plane i to plane j. T₁₀=T₁₁=T₁₂=T_{H} (room temperature).

The conduction heat transfer of the leg and base of the stator support frame is Q1 and Q3, and the conduction heat transfer of the side and ceil surface of the radiation heat shield is Q5 and Q6, the calculation is as follows:

$${Q}_{1} = \frac{{A}_{L e g}}{{H}_{L e g} + {H}_{B a s e} / 2} {\int }_{{T}_{B a s e}}^{{T}_{H}} {κ}_{g 10} ( T ) d T$$

$${Q}_{3} = \frac{{A}_{Cover}}{{H}_{s} + {H}_{Base} / 2} {\int }_{{T}_{B a s e}}^{{T}_{Cover}} {κ}_{g 10} ( T ) d T$$

$${Q}_{5} = \frac{{A}_{Shield}}{{H}_{Shield}} {\int }_{{T}_{Cover}}^{{T}_{Shield}} {κ}_{g 10} ( T ) d T$$

$${Q}_{6} = \frac{{A}_{Ceil}}{{H}_{Ceil}} {\int }_{{T}_{Shield}}^{{T}_{Ceil}} {κ}_{g 10} ( T ) d T$$

where A_{Leg}, A_{Cover}, A_{Shield} and A_{Ceil} are the representative cross-sections of the leg of the stator support frame, the protective cover, the radiation heat shield, and the ceil, respectively. T_{Base}, T_{cover}, T_{Shield} and T_{Ceil} are the temperatures of the base of the stator support frame, the protective cover, the radiation heat shield, and the ceil, respectively. In addition, K_{g10} represents the thermal conductivity of the material G10.

The calculation of the conduction heat transfer Qᵤ and Q_{L} on the upper and lower surfaces of each superconducting coil is as follows:

$${Q}_{U} = \frac{{A}_{Sup}}{{H}_{Cover}} {\int }_{{T}_{L}}^{{T}_{3}} {κ}_{g 10} ( T ) dT$$

$${Q}_{L} = \frac{{A}_{L}}{{N}_{Sup} {H}_{L}} {\int }_{{T}_{L}}^{{T}_{Base}} {κ}_{g 10} ( T ) dT$$

where N_{Sup} denotes the number of superconducting coils, A_{Sup} and A_{L} denote the transverse representative cross-sectional areas of the ceil and the base of the superconducting coil, T_{L} denotes the superconductor temperature.

The amount of the heat transfer Q_{S} of the current wire between the vacuum wall and the radiation heat shield and the amount of the heat transfer Q_{V} of the current wire between the radiation heat shield and the rotor are calculated as follows:

$${Q}_{S} = {N}_{Forcer} {N}_{Leads} {I}_{m} \sqrt{2 {\int }_{{T}_{1}}^{{T}_{m}} {κ}_{Cu} ( T ) {ρ}_{Cu} ( T ) dT}$$

$${Q}_{V} = {N}_{Forcer} {N}_{Leads} {I}_{m} \sqrt{2 {\int }_{{T}_{7}}^{{T}_{H}} {κ}_{Cu} ( T ) {ρ}_{Cu} ( T ) dT}$$

where N_{Forcer} and N_{Leads} denote the number of three-phase coils and the number of wires, respectively, K_{Cu} and ρ_{Cu} denote the thermal conductivity and resistivity of copper, respectively, the amount of the heat transfer Q_{W} from the wire to the superconducting coil is as follows:

$${Q}_{W} = {I}_{s} \sqrt{2 {\int }_{{T}_{L}}^{{T}_{H}} {κ}_{Cu} ( T ) {ρ}_{Cu} ( T ) dT}$$

Step S42: The heat required for cooling is calculated according to the equilibrium relationship of each amount of heat transfer.

The equilibrium relationship is as follows:

$${q}_{3} + {N}_{S u p} {Q}_{U} = 0$$

$${Q}_{5} + {q}_{2} + {q}_{8} = 0$$

$${Q}_{6} - {Q}_{s} - {Q}_{v} + {q}_{1} + {q}_{7} = 0$$

$${Q}_{3} - {Q}_{5} = 0$$

$${Q}_{1} + {Q}_{3} - {q}_{9} - {N}_{S u p} {Q}_{L} = 0$$

$${Q}_{m} - {q}_{4} - {q}_{5} - {q}_{6} = 0$$

The first three formulas refer to the heat equilibrium on planes 3, 6, and 7, respectively, the fourth and fifth formulas denote the equilibrium relationship around the branch point of the base and the protective cover, and the last formula denotes the equilibrium around the rotor.

The Joule heat of the rotor coil is as follows:

$${Q}_{m} = ( 3 / 2 ) {N}_{F o r c e r} {N}_{m} {ρ}_{C u} ( {T}_{m} ) {\overline{I}}_{m}^{2} {L}_{c} / {S}_{w}$$

where L_{c} and S_{W} are the circumference of the coil and the cross-sectional area of the coil wire, respectively, Īₘ is the average value of Iₘ, and Tₘ is the temperature of the rotor. In addition, the thickness of the protective cover is small enough, so for simplicity, Q4=0.

The following assumptions are made for the temperature of each surface:

$${T}_{1} = {T}_{7} = ( {T}_{C e i l} + {T}_{Shield} ) / 2$$

$${T}_{2} = {T}_{8} = ( {T}_{C o ν e r} + {T}_{Shield} ) / 2$$

$${T}_{4} = {T}_{5} = {T}_{6} = {T}_{m}$$

The unknown numbers T_{Ceil}, T_{Shield}, T₃, Tₘ, T_{Base} and T_{Cover} are solved by the equilibrium formula to calculate the amount of the heat transfer.

Step S43: The cooling system is determined according to the heat required for cooling.

The calculation formula of the AC loss of the superconducting coil is as follows:

$${Q}_{A C} = 2 / ( 3 {μ}_{0}^{2} ) ( {B}_{e x}^{3} / {H}_{p x} + {B}_{e z}^{3} / {H}_{p z} ) {f}_{m} {V}_{S C}$$

where Q_{AC} is the AC loss of the superconducting coil, the external magnetic field provided by the rotor coil is (Bₑₓ, B_{ez}), fₘ=v̅/(2τ) is the representative frequency of the external magnetic field, V_{SC} is the volume of the superconductor directly below the rotor, V_{SC}=N_{coil}A_{coil}Hₛζₛ; v̅, N_{coil} and A_{coil} are the average speed of the rotor, the number of coils of the rotor and the projection area of a single coil on the stator surface, respectively. It is assumed that the external magnetic fields Bₑₓ and B_{ez} are sufficiently smaller than the penetration fields Bₚₓ and B_{pz} of the superconductor, respectively,

$${B}_{p x} = \begin{matrix}{μ}_{0} ( 1 - {I}_{s} / {I}_{c} ) {H}_{p x} & {H}_{p x} = {I}_{c} / ( 2 {t}_{t a p e} )\end{matrix}$$

$${B}_{p z} = {μ}_{0} ( 1 - {I}_{s} / {I}_{c} ) \begin{matrix}{H}_{p z} & {H}_{p z} = {I}_{c} / ( 2 {H}_{s} )\end{matrix}$$

The external magnetic field calculation process of the rotor coil is as follows:

The shape of the rotor coil is generally racetrack-shaped, but for simplicity, it is assumed to be a rectangle (Wₘ×Lₘ×Hₘ) with a width of bₘ, the calculation formula of the magnetic field around the coil (Bₑₓ, B_{ey}, B_{ez}) is as follows:

$${B}_{e x} ( x , y , z ) = \frac{{μ}_{0} {J}_{m}}{4 π} [ f ( Z , Y , X ) {\vert}_{{X}_{1}}^{{X}_{2}} - f ( Z , Y , X ) {\vert}_{{X}_{3}}^{{X}_{4}} ] {\vert}_{{Y}_{2}}^{{Y}_{3}} {\vert}_{{Z}_{1}}^{{Z}_{2}}$$

$${B}_{e y} ( x , y , z ) = \frac{{μ}_{0} {J}_{m}}{4 π} [ - f ( Z , X , - Y ) {\vert}_{{Y}_{1}}^{{Y}_{2}} + f ( Z , Y , - Y ) {\vert}_{{Y}_{3}}^{{Y}_{4}} ] {\vert}_{{X}_{1}}^{{X}_{4}} {\vert}_{{Z}_{1}}^{{Z}_{2}}$$

$${B}_{e z} ( x , y , z ) = \frac{{μ}_{0} {J}_{m}}{4 π} \{ [ f ( X , Y , Z ) {\vert}_{{X}_{1}}^{{X}_{2}} - f ( X , Y , Z ) {\vert}_{{X}_{3}}^{{X}_{4}} ] {\vert}_{{Y}_{2}}^{{Y}_{3}} + [ f ( Y , X , Z ) {\vert}_{{Y}_{1}}^{{Y}_{2}} - f ( Y , X , Z ) {\vert}_{{Y}_{3}}^{{Y}_{4}} ] {\vert}_{{X}_{1}}^{{X}_{4}} \} {\vert}_{{Z}_{1}}^{{Z}_{2}}$$

The current density of the rotor coil is Jₘ=Nₘ Īₘ/(Hₘbₘζₘ), and the integral interval is defined as follows:

$${X}_{1} = x + {W}_{m} / 2$$

$${X}_{2} = x + {W}_{m} / 2 - {b}_{m}$$

$${X}_{3} = x - {W}_{m} / 2 + {b}_{m}$$

$${X}_{4} = x - {W}_{m} / 2$$

$${Y}_{1} = y + {L}_{m} / 2$$

$${Y}_{2} = y + {L}_{m} / 2$$

$${Y}_{3} = y - {L}_{m} / 2 + {b}_{m}$$

$${Y}_{4} = y - {L}_{m} / 2$$

$${Z}_{1} = z + {H}_{m} / 2$$

$${Z}_{2} = z - {H}_{m} / 2$$

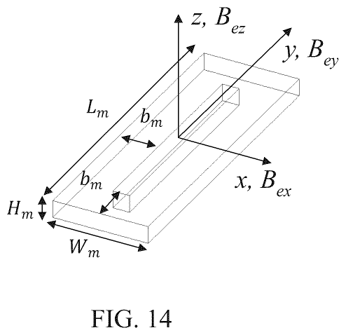

As shown in FIG. 14, the definition of the integrand f is as follows:

$$f ( u , v , w ) = v log ( w + Λ ) + w log ( v + Λ ) - u {tan}^{- 1} ( \frac{vw}{uΛ} ) - u {tan}^{- 1} ( \frac{v}{u} ) - v$$

$$Λ = \sqrt{{u}^{2} + {v}^{2} + {z}^{2}}$$

The formula for calculating the heat Q_{c} required for cooling the superconducting coil is as follows:

$${Q}_{c} = {N}_{Sup} ( {Q}_{L} + {Q}_{U} ) {Q}_{W} + {Q}_{A C}$$

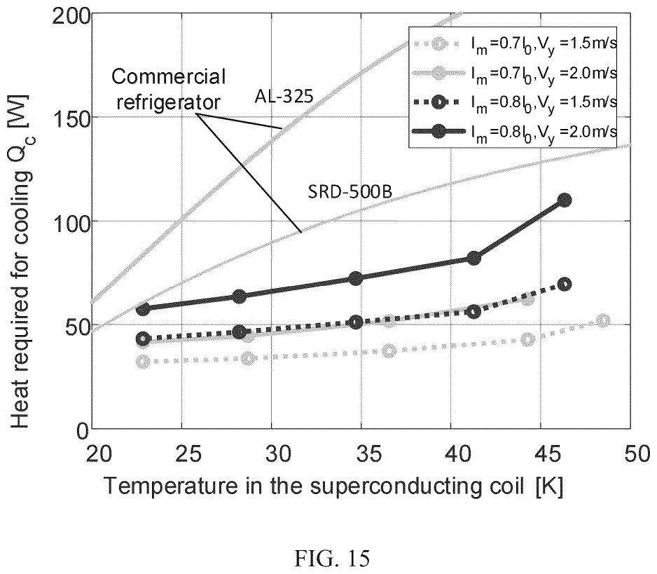

Based on the calculation results of the above amounts of heat transfer, the relationship between the heat Qc required for cool the superconducting coil and the superconductor temperature is shown in FIG. 15. It can be seen from the figure that Qc is less than the cooling capacity of the commercial single-stage refrigerator.

Finally, it should be explained that the above embodiments are only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

1. A low-loss superconducting motor, comprising a vacuum chamber, wherein a stator component and a rotor component are installed in the vacuum chamber, and a protective cover is arranged between the stator component and the rotor component; a first one of the stator component and the rotor component is equipped with an ordinary conducting coil, and a second one of the stator component and the rotor component is equipped with a superconducting coil, the superconducting coil is applied with a direct current, and the ordinary conducting coil is applied with an alternating current.

2. The low-loss superconducting motor according to claim 1, wherein the rotor component comprises a rotor support frame and a plurality of superconducting coils arranged on the rotor support frame, and the stator component comprises a stator support frame and the ordinary conducting coil arranged on the stator support frame.

3. The low-loss superconducting motor according to claim 2, wherein the plurality of superconducting coils are circumferentially distributed on an interior of the stator support frame, two ends of the stator support frame are fixedly connected to two ends of the vacuum chamber, a plurality of ordinary conducting coils are circumferentially distributed on an outer side of the rotor support frame, two ends of the stator support frame are fixedly connected to the two ends of the vacuum chamber, two ends of the rotor support frame are connected to the two ends of the vacuum chamber through a rotary bearing, and the plurality of superconducting coils and the plurality of ordinary conducting coils are located in an identical axial position.

4. The low-loss superconducting motor according to claim 3, wherein the protective cover is set on a circumferential side of the rotor support frame, and a radiation heat shield is arranged between the stator support frame and the rotor support frame.

5. The low-loss superconducting motor according to claim 1, wherein the rotor component comprises a rotor support frame and a plurality of ordinary conducting coils arranged on the rotor support frame, and the stator component comprises a stator support frame and the superconducting coil arranged on the stator support frame.

6. The low-loss superconducting motor according to claim 5, wherein a ceil of the stator support frame is a planar structure, and a plurality of arrayed superconducting coils are arranged on the planar structure, vertical polarities of adjacent superconducting coils are different.

7. The low-loss superconducting motor according to claim 6, wherein the planar structure is covered with a plurality of thermal insulation films, and the protective cover is arranged above the plurality of arrayed superconducting coils, the protective cover is made of non-metallic material, and a radiation heat shield is arranged on the protective cover.

8. The low-loss superconducting motor according to claim 5, wherein the rotor support frame is a frame structure, at least one set of the plurality of ordinary conducting coils is arranged inside the frame structure, and each set of the plurality of ordinary conducting coils comprises at least two ordinary conducting coils.

9. A design method for the low-loss superconducting motor according to claim 1, comprising the following steps:
step S1: calculating a stator magnetic field according to an actual acceleration required;
step S2: calculating a current of the superconducting coil according to the stator magnetic field;
step S3: calculating a critical current and a superconductor temperature according to the current of the superconducting coil;
step S4: determining a cooling system according to the superconductor temperature.

10. The design method according to claim 9, wherein step S4 is as follows:
step S41: calculating an amount of heat transfer, the heat transfer comprises a radiation heat transfer, a conduction heat transfer, and a wire heat transfer;
step S42: calculating heat required for cooling according to an equilibrium relationship of each heat transfer;
step S43: determining the cooling system according to the heat required for cooling.

11. The design method according to claim 9, wherein in the low-loss superconducting motor, the rotor component comprises a rotor support frame and a plurality of superconducting coils arranged on the rotor support frame, and the stator component comprises a stator support frame and the ordinary conducting coil arranged on the stator support frame.

12. The design method according to claim 11, wherein in the low-loss superconducting motor, the plurality of superconducting coils are circumferentially distributed on an interior of the stator support frame, two ends of the stator support frame are fixedly connected to two ends of the vacuum chamber, a plurality of ordinary conducting coils are circumferentially distributed on an outer side of the rotor support frame, two ends of the stator support frame are fixedly connected to the two ends of the vacuum chamber, two ends of the rotor support frame are connected to the two ends of the vacuum chamber through a rotary bearing, and the plurality of superconducting coils and the plurality of ordinary conducting coils are located in an identical axial position.

13. The design method according to claim 12, wherein in the low-loss superconducting motor, the protective cover is set on a circumferential side of the rotor support frame, and a radiation heat shield is arranged between the stator support frame and the rotor support frame.

14. The design method according to claim 9, wherein in the low-loss superconducting motor, the rotor component comprises a rotor support frame and a plurality of ordinary conducting coils arranged on the rotor support frame, and the stator component comprises a stator support frame and the superconducting coil arranged on the stator support frame.

15. The design method according to claim 14, wherein in the low-loss superconducting motor, a ceil of the stator support frame is a planar structure, and a plurality of arrayed superconducting coils are arranged on the planar structure, vertical polarities of adjacent superconducting coils are different.

16. The design method according to claim 15, wherein in the low-loss superconducting motor, the planar structure is covered with a plurality of thermal insulation films, and the protective cover is arranged above the plurality of arrayed superconducting coils, the protective cover is made of non-metallic material, and a radiation heat shield is arranged on the protective cover.

17. The design method according to claim 14, wherein in the low-loss superconducting motor, the rotor support frame is a frame structure, at least one set of the plurality of ordinary conducting coils is arranged inside the frame structure, and each set of the plurality of ordinary conducting coils comprises at least two ordinary conducting coils.

18. The design method according to claim 11, wherein step S4 is as follows:
step S41: calculating an amount of heat transfer, the heat transfer comprises a radiation heat transfer, a conduction heat transfer, and a wire heat transfer;
step S42: calculating heat required for cooling according to an equilibrium relationship of each heat transfer;
step S43: determining the cooling system according to the heat required for cooling.

19. The design method according to claim 12, wherein step S4 is as follows:
step S41: calculating an amount of heat transfer, the heat transfer comprises a radiation heat transfer, a conduction heat transfer, and a wire heat transfer;
step S42: calculating heat required for cooling according to an equilibrium relationship of each heat transfer;
step S43: determining the cooling system according to the heat required for cooling.

20. The design method according to claim 13, wherein step S4 is as follows:
step S41: calculating an amount of heat transfer, the heat transfer comprises a radiation heat transfer, a conduction heat transfer, and a wire heat transfer;
step S42: calculating heat required for cooling according to an equilibrium relationship of each heat transfer;
step S43: determining the cooling system according to the heat required for cooling.
